(19) United States
(12) Patent Application Publication
(10) Pub. No.: US 2002/0185063 A1
(43) Pub. Date: Dec. 12, 2002

(54) Sealing roller glue tank

(76) Inventor: Roan Kuang-Wen, Taipei (TW)

Correspondence Address: DOUGHERTY & TROXELL, 5205 LEESBURG PIKE, SUITE 1404, FALLS CHURCH, VA, 22041, US

(21) Appl. No.: 09/878,280

(22) Filed: Jun. 12, 2001

(51) Int. Cl. B05C 1/00

(52) U.S. Cl. 118/258; 118/200; 118/270

(57) ABSTRACT

A sealing roller glue tank comprises a glue storage groove and a wet-retaining sealing cover. The groove have a roller for adjusting glue, a upper glue wheel part of which is exposed to the groove, and a high density fiber sponge for buffering the pressure of glue; a double layer glue guide plate positioned on the roller and upper glue wheel for guiding and retaining glue. The sealing cover is capable of covering on the groove. A sealing unit such as sponge or rubber is installed at an end plate with respect to the groove for sealing the groove to be wet-retaining and isolate from the external environment. A high density sponge is installed at the sealing cover facing to the notch of the groove. By filling high density fiber sponge in the groove to absorb liquid glue for buffering pressure of glue, transferring unit a descending unit, a coating machine can be actuated in time and rotated to a predetermined position without pouring glue repeatedly. The upper glue wheel can be lifted to rotate idly or to suspend a work of feeding paper without drying glue on the surface of the roller. Before stopping the sealing roller glue tank, the glue is transferred by a transferring unit so that the sealing roller glue tank returns to an upside down position and is sealed for wet-retaining. The roller is unnecessary to be washed and the glue does not dry.

### BACKGROUND OF THE INVENTION

The sealing roller glue tank of the present invention is used to improve the defects in the prior art, such as each time before coating liquid glue and lighting, the glue must be poured to the groove. After operation, the glue must be taken out for sending to a can. Furthermore, a large amount of solvent is used to wash the glue tank and coating the rollers. In the present invention, glue is stored in a sealing roller glue tank in advance, which can be actuated at any desired time or stops the coating operation without closing the machine. The glue is unnecessary to be washed.

Currently, the glue used in the lighting and coating processes to the surface of a printing products, if naturally evaporate synthetic resin glue (comprising aqueous solvable and oil solvable) which is used in coating, lighting the mechanical device for object to be printed is used as a basic component, after operating, all the glue must be restored to a storage can, and before stopping, the aqueous solvable glue must be diluted or the surface of the gluing roller and glue storage tank must be washed by oil solvable, otherwise the glue exposed to the air will evaporate and then dry. Similarly, each time as the machine is started up, the glue must be filled again, and as the machine is stopped, it must be washed. This is time and labor-consumed and is uneconomical.

In summary, the coating machine can be divided into the following three types:

1. As shown in FIG. 1, a finishing machine for lighting a printed surface of general paper printing products is illustrated. The machine has an upper glue wheel A for coating and lighting, a metal rotary wheel B for transferring and extrusion work piece, and a roller C and a glue storage tank F with respect to the upper glue wheel A. A knife G is installed at another side with respect to the metal roller B for scraping the glue adhered to the metal roller B. The glue is transferred to be between the upper glue wheel A and the roller C for gluing by the upper glue wheel A. The surplus glue is drained out from edges of the two wheels A and C. As shown in FIG. 2, it is returned to the storage tank F for reuse.

2. With reference to FIG. 3, this kind of resin lighting machine is usually used in the lighting process of a small working object, the roller C is directly adhered with glue of the glue tank F1 and then transferred the glue to the upper glue wheel A for gluing to the work piece H. The metal rotary wheel B is installed with the G and is positioned above the storage tank F.

3. Referring to FIG. 4, to glue the work piece H for being used to the gluing machine, the wheel B is adhered with glue of the storage tank F for being transferred to the upper glue wheel A. Thus, no scraping knife is designed, while a right and left rollers C and D are equipped for pressing the work piece H so that the gluing work is complete.

From above description of the lighting and gluing structures, the wheels and gluing are exposed to air, the glue is easy to dry. in air and each time as the machine is stopped, other than the metal rotary wheel C is washless since the scraping knife is used to scrape glue, the other wheel and storage tank must be washed and the glue must be returned to the storage tank. As it is used again, the glue is poured out again. The process is tedious and is time and labor-consumed.

### SUMMARY OF THE INVENTION

Accordingly, the primary object of the present invention is to provide a sealing roller glue tank comprising a glue storage groove and a wet-retaining sealing cover. The groove have a roller for adjusting glue, an upper glue wheel part of which is exposed to the groove, and a high density fiber sponge for buffering the pressure of glue; a double layer glue guide plate positioned on the roller and upper glue wheel for guiding and retaining glue. The sealing cover is capable of covering on the groove. A sealing unit such as sponge or rubber is installed at an end plate with respect to the groove for sealing the groove to be wet-retaining and isolate from the external environment. A high density sponge is installed at the sealing cover facing to the notch of the groove. By filling high density fiber sponge in the groove to absorb liquid glue for buffering pressure of glue, transferring unit a descending unit, a coating machine can be actuated in time and rotated to a predetermined position without pouring glue repeatedly. The upper glue wheel can be lifted to rotate idly or to suspend a work of feeding paper without drying glue on the surface of the roller. Before stopping the sealing roller glue tank, the glue is transferred by a transferring unit so that the sealing roller glue tank return to an upside down position and is sealed for wet-retaining. The roller is unnecessary to be washed and the glue does not dry.

The various objects and advantages of the present invention will be more readily understood from the following detailed description when read in conjunction with the appended drawing.

### BRIEF DESCRIPTION OF THE DRAWINGS

FIG. 1 shows a prior machine used in the lighting operation of a paper.

FIG. 2 is a schematic view for returning glue in FIG. 1.

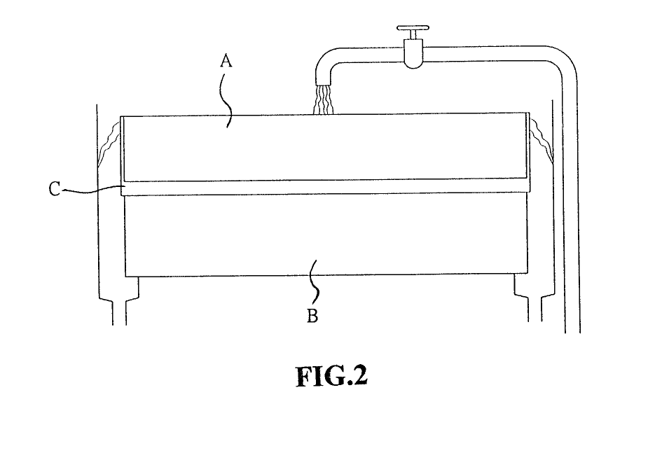

FIG. 3 shows a table top machine for lighting vertically in the prior art.

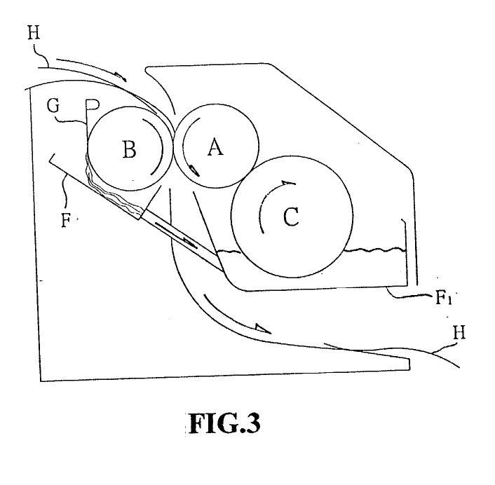

FIG. 4 is a gluing machine of the prior art.

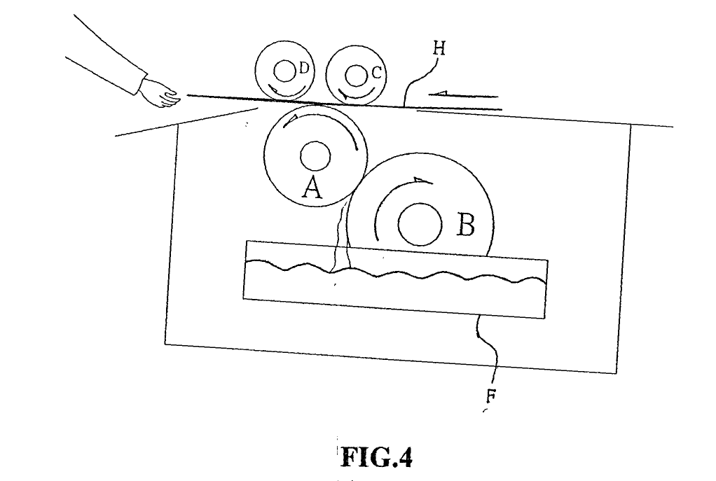

FIG. 5 is an exploded perspective view of the present invention.

FIG. 6 is a plane assembly cross sectional view of the present invention.

FIG. 7 is a schematic view showing the rotation operation of the present invention.

FIG. 8 shows the operation of descending in the present invention.

FIG. 9 shows the operation of the present invention.

FIG. 10 shows the lifting operation of the present invention.

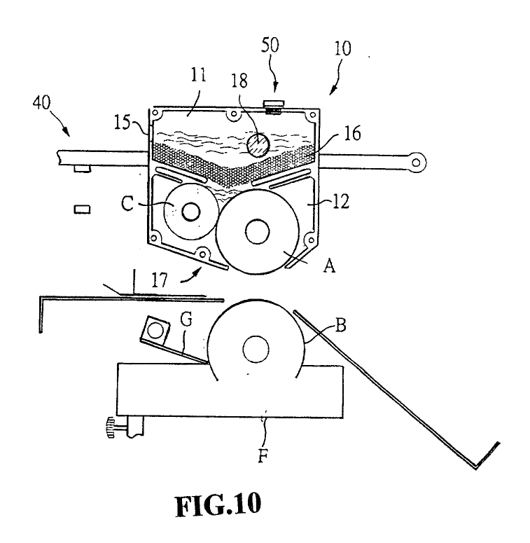

FIG. 11 is a schematic view showing the present invention being storage.

FIG. 12 is an operational schematic view showing the present invention being used again.

FIG. 13 is a schematic view showing the present invention is used to a continuous coating system.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

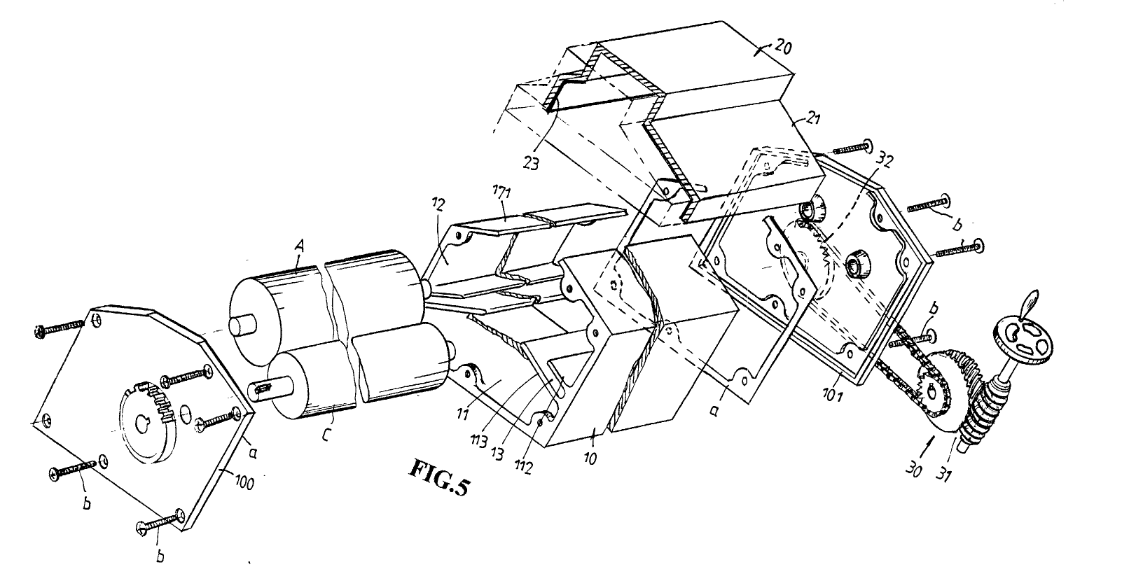

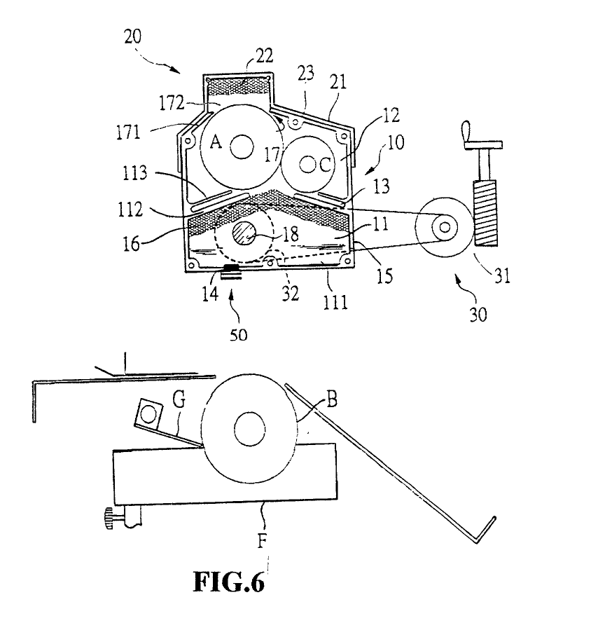

The sealing roller glue tank of the present invention has the effect of retaining glue not to dry and without washing. In the present invention, the upper glue wheel A, roller C and the chamber 11 are installed in the groove 10, as shown in FIGS. 5 and 6. The groove 10 is formed integrally. Two sides are locked with covers 100 and 101 by sealing pads 1 and a plurality of screws b. so as to be formed as sealing groove. The groove 10 has an action end 17 having an opening 172 for gluing by the upper glue wheel A. Other than correcting and alignment as the sealing cover 20 are sealed, an end plate 171 tilt at right and left sides is beneficial to form the opening 172 for coating as the upper glue wheel A and roller C are contacted with one another. The left and right sides of the sealing cover 20 have cover plates 21 for matching to the end plate 171 of the groove 10. At the position of the covering plate 20 with respect to the end plate 171 is installed with a sealing unit 23 made of sponge or rubber so that as the end plate 171 of the groove 10 covers, it has the effect of sealing, wet-retaining and isolation.

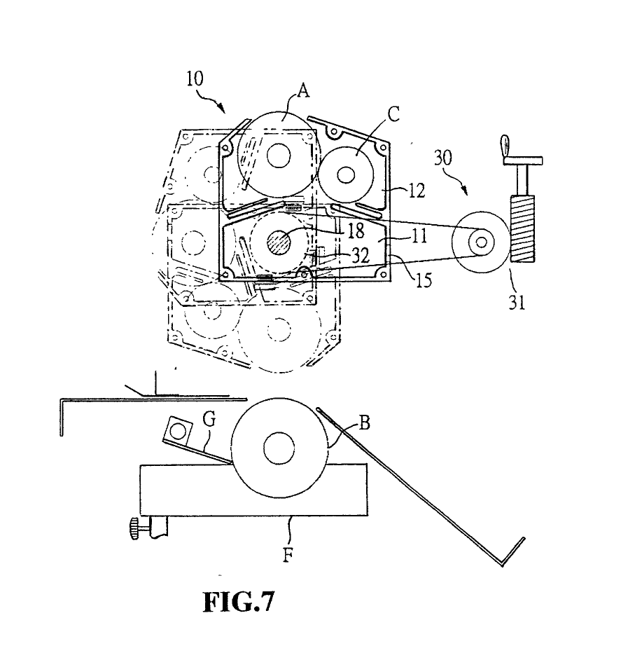

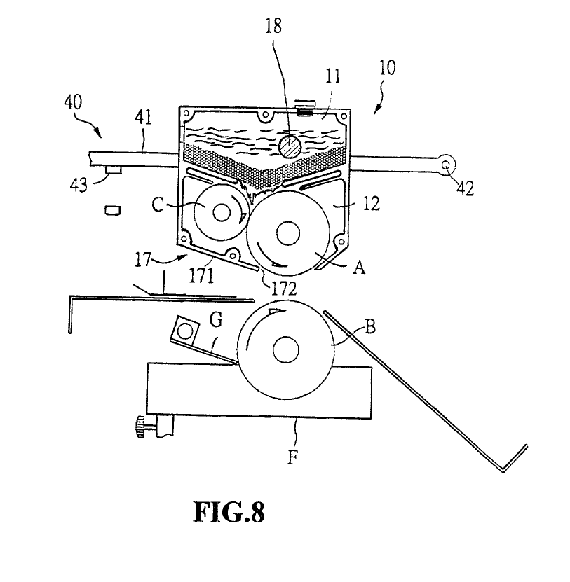

A sponge 22 is installed in the cover 20 facing to the opening 172 fo the groove 10. The sponge 22 is added with different solvent according to the property of the glue so as to retain the wetness of the glue in the groove 10. If the oil glue 111 is used, then the additives of the sponge 22 is oil solvent, such as xylene. The glue 111 used is aqueous resin, then the additives is water. This sponge 22 is high density sponge 22 and can store additives for a long time effectively. Thereby, when tripping, by the groove 10 and sealing cover 20, the upper glue wheel A and roller C are placed on the glue chamber 11 for sealing so that the glue is unnecessary to be returned. Furthermore, it will not dry and is unnecessary to be washed. The glue flowing into the liquid storage groove F can be poured into the glue chamber 11 of the groove 1. If it is necessary to be washed, only the liquid storage groove F is necessary to be washed. Therefore, not only the operation before using or after stripping is convenient, but also time and power are saved. In using, the sealing cover 20 is taken out, by a transferring unit 30, the groove 10 is controlled to rotate through 180 degrees. With reference to FIGS. 7-9, the opening 172 is distanced with a proper distance to the rotary wheel B. Then, the descending unit 40 descends the groove 10 so that the upper glue wheel A is in contact with the rotary wheel B. Then the operation of lighting or gluing is performed. When tripping, the descending unit 40 lifts the groove 10 to a proper distance, then the sealing cover 20 is rotated to return as that shown in FIG. 6. When the groove 10 lifts through a distance, it is rotated so that as groove 10 rotates, the edge will not contact the rotary wheel B.

In the embodiment of the transferring unit 30, the turbine, turbine rod 31 are used to drive the driven wheel 32 on the outer axle post 18 of the groove 10 so that the groove 10 will rotate. This transferring unit 30 can be a motor with teeth, or by chain, various ways can be used. The descending unit 40 swings along the central shaft 42 at one end of the arm 41. By the resisting of the middle end and the axle post 18, the lifting of the groove 10 is controlled. A stop 43 is used to position. In fact, the descending operation can be performed by cam or teeth. The transferring unit 30 and descending unit 40 are known in the prior art, thus the detail will not be further described.

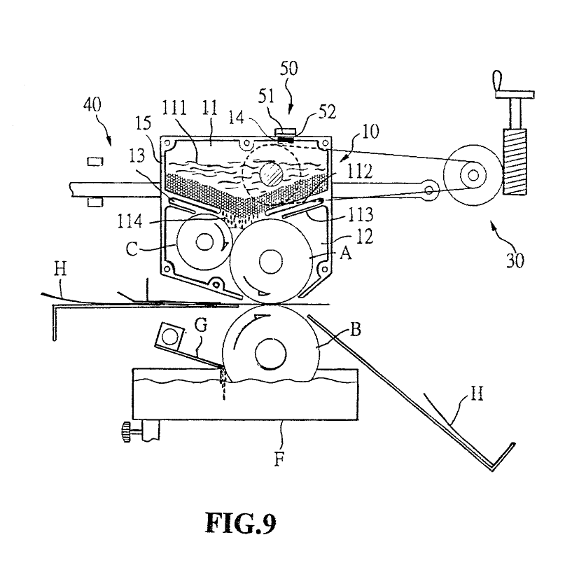

The feature of the sealing roller glue tank of the present invention is groove 10 and sealing cover 20. The sealing cover 20 is described. The groove 10 is illustrated in the embodiment shown in FIG. 9. The groove 10 is formed with a chamber 11 with glue 111 and wheel chamber 12. A tilt left and right glue guide plates 112 are used to space the two. The glue guides plate 112 tend to the wheel chamber 12. The interaction of the glue guide plate 112 is installed with a glue outlet 114. It is preferably that the glue outlet 114 is between the upper glue wheel A and the roller C. the right and left glue guide plate 112 in the chamber 11 is installed with a sponge 16. The wall of the chamber 11 is formed with a hole 4 for injecting glue and a window 15 for viewing the glue 111 in the chamber 11. To seal hole 14, a piston 50 is used to seal it. The piston 50 is made by screws 51 with a pad 52 to screw into the hole 14 or it is sealed by H shape plug of rubber.

A sub-plate 113 protruded from the glue guide plate 112 in the wheel chamber 12. The glue guide plate 112 is formed with a receiving space 13. The object is that as the groove 10 rotates for tripping or places with upside down in idle, it will prevent the glue 111 between the upper glue wheel A and the roller C from returning back to the wheel chamber 12 so as to effect the gluing operation. It is preferred that the distance between the front end of the sub-plate 113 and the upper glue wheel A and roller C. This will be described hereinafter.

The sponge 16 in the chamber 11 is a high density material. It has the effect of preventing from movement and has the function of causing the glue to flow from the sponge 16 slowly.

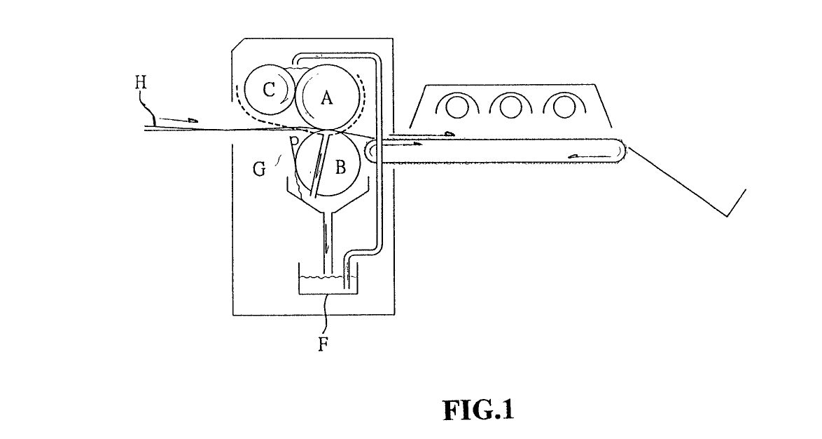

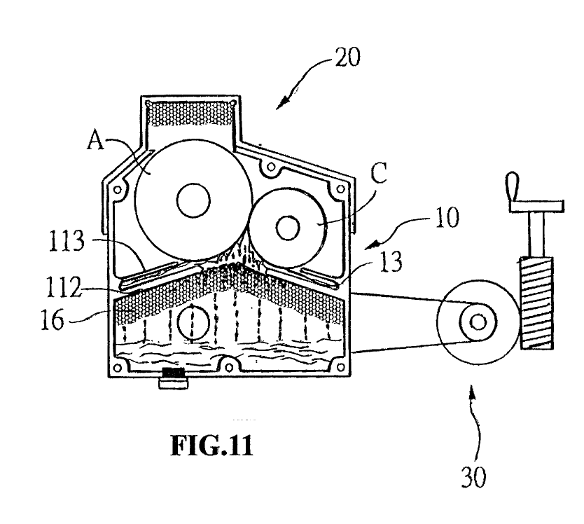

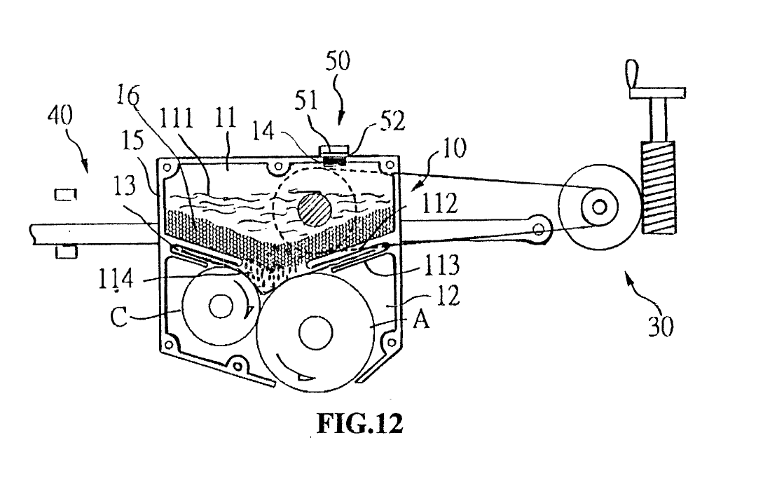

As the sealing roller glue tank of the present invention is stopped, the descending unit 40 will lift the groove 10 upwards thereby a distance as illustrated in FIG. 1. Then the transferring unit 30 rotates upwards. After the sealing cover 20 is sealed, the groove 10 is retained to be wet as shown in FIG. 11. Then, the glue between the upper glue wheel A and roller C flows downwards. A part of the glue enters into the chamber 11 and a part flows into the receiving space 13 along the glue guide plate 112. The design of the receiving space 13 cause that as the present invention is stopped again and the groove 10 rotates to a lower position as shown in FIG. 12, the glue 111 stored in the receiving space 10 will flow along the sub-plate. The distance between the upper glue wheel A and roller C is very small, and the glue has a certain concentration. If there is no external force or no extrusion of the glue permeated from the chamber 11, the glue will not flow out from the edge of the wheel. As the groove 10 rotates to a predetermined position, the glue 111 in the chamber 11 does not flow out from the sponge 16. Now, the glue in the receiving space 13 can be used until the glue is supplied normally. It is appreciated that if no this receiving space 13, as the groove 10 rotates upwards, a part of the glue will flow to the glue guide plate 112 at the wheel chamber 12. When the groove 10 rotates downwards, the glue will flow from the wall directly to the opening 172 so as to interfere the normal operation of gluing.

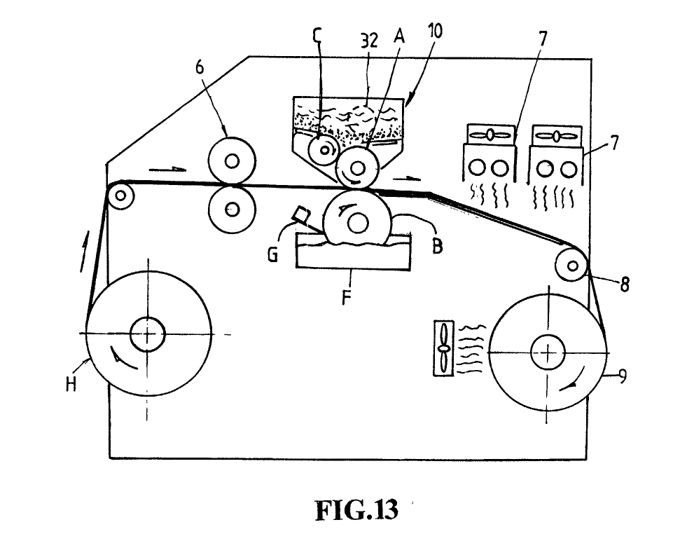

Besides, if the present invention is used to a continuous coating system for lighting and gluing operations, a material transfer wheel set 6 can be used for smoothing and pulling a work piece, coating, lighting, etc., as shown in FIG. 13. In that, the present invention is installed between the material transfer wheel set and drying fan 7. The material winding (work piece) H is transferred by the material transfer wheel set 6 to the upper glue wheel A of the present invention. Then it is processed by the drying fan 7, wheels 8 and then to the product wheel machine for winding. The whole system can be operated automatically. Not only the yield increases greatly, but also difference of the rotation speed between the upper glue wheel A and the material transfer wheel set 6, the work piece H between the upper glue wheel A and the material transfer wheel set will pull straightly. Since the rotary speed of the upper glue wheel A is larger than the amount of material feeding, the filling to the surface organ of the work piece H will be improved. However, by control the coating thickness of the working piece, a high quality coating product is formed.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sealing roller glue tank comprising a glue storage groove and a wet-retaining sealing cover, wherein the groove have a roller for adjusting glue, a upper glue wheel part of which is exposed to the groove, and a high density fiber sponge for buffering the pressure of glue, a double layer glue guide plate positioned on the roller and upper glue wheel for guiding and retaining glue; the sealing cover is capable of covering on the groove; a sealing unit such as sponge or rubber is installed at an end plate with respect to the groove for sealing the groove to be wet-retained and isolate from the external environment; a high density sponge is installed at the sealing cover facing to the notch of the groove; by filling high density fiber sponge in the groove to absorb liquid glue for buffering pressure of glue, transferring a descending unit, a coating machine can be actuated in time and rotated to a predetermined position without pouring glue repeatedly; the upper glue wheel can be lifted to rotate idly or to suspend a work piece of feeding paper without drying the glue on the surface of the roller; before stopping the sealing roller glue tank, the glue is transferred by a transferring unit so that the sealing roller glue tank returns to an upside down position and is sealed for wet-retaining; the roller is unnecessary to be washed and the glue does not dry.

2. The sealing roller glue tank as claimed in claim 1, wherein the transferring unit is formed by a post protruded from one lateral side of the groove for combining with a turbine and a driven wheel driven by a turbine rod unit; the turbine and turbine rod are rotated manually or dynamically to drive the driven wheel so that the groove rotate through 180 degrees.

3. The sealing roller glue tank as claimed in claim 1, wherein the descending unit is formed by an arm having an end axially engaged to a central shaft, and is positioned and fixed by two stoppers; by the arm to resist the post, the lifting of the groove is controlled.
